(19) United States
(12) Patent Application Publication
(10) Pub. No.: US 2010/0058902 A1
(43) Pub. Date: Mar. 11, 2010

(54) Peeling machine and peeling method, particularly for unstraightened work pieces and/or for work pieces having a diameter greater than 80 mm

(76) Inventors: Alfred Bartz, Walhorn/Lontzen (BE); Michael Diethert, Erftstadt-Lechenich (DE)

Correspondence Address: COLLARD & ROE, P.C., 1077 NORTHERN BOULEVARD, ROSLYN, NY, 11576, US

(21) Appl. No.: 12/462,575

(22) Filed: Aug. 5, 2009

Related U.S. Application Data
(60) Provisional application No. 61/191,728, filed on Sep. 11, 2008.

(51) Int. Cl. B23B 5/08; B23B 5/12; B23B 13/00; B23B 17/00

(52) U.S. Cl. 82/124; 82/117; 82/149

(57) ABSTRACT

Material loss can be reduced by means of floating clamping of a work piece during peeling.

The invention relates to a peeling machine and to a peeling method, particularly for unstraightened work pieces and/or for work pieces having a diameter greater than 80 mm.

Increased requirements for round rods, also in the case of large diameters, in other words particularly in the case of diameters that exceed 80 mm or 100 mm, make it necessary, to an increasing degree, for such work pieces to be subjected to a peeling process, during which the surface is corrected. In this way, scale and the like can be removed from the surface, and generally, lathes or peeling machines are used for this purpose.

In this connection, known peeling machines have the disadvantage that relatively a lot of material has to be removed, and therefore such work pieces become relatively expensive, particularly at increasing diameters.

It is the task of the invention to provide a remedy here.

As a solution, the invention proposes, on the one hand, a peeling machine that is characterized by a guide carriage that can be displaced axially relative to a peeling head, and has a clamping device that can be displaced perpendicular to this.

A guide carriage having a clamping effect guarantees, on the one hand—and does so actually independent of the other characteristics of the present invention—that rotational forces that can be introduced into the work piece by means of a peeling process can be effectively countered by way of the guide carriage with its clamping device, without any relative movement having to take place between the clamping device and the work piece during the peeling process, as long as the clamping device is engaged. In this manner, wear and surface stress on the work piece can be minimized.

The displaceable clamping device makes it possible, on the other hand, for the work piece to be guided to a peeling head by the guide carriage outside of its center, so that a curvature of the work piece, which it can certainly have, for example after rolling or forging processes, can easily be followed by the peeling machine.

In deviation from the state of the art, according to which the work pieces are guided through a peeling head in a straight line, it is therefore possible, by means of the displaceable clamping device on the guide carriage, to guide the work piece through the peeling head along a curved or changing path. This makes it particularly possible for the work piece to be guided through the peeling head essentially along its own center line, even if this line is curved. In this way, material losses can be reduced, since according to the state of the art, with its straight-line guidance, the greatest straight-line cylinder diameter, which can be disposed within the entire curved work piece, represents the measure to which the work piece must be reduced, while in the case of the present invention, a significantly greater radius can be left over the longitudinal axis of the work piece.

A guide device can be disposed between the guide carriage with its displaceable clamping device and the peeling head, which device is disposed fixed in place relative to the peeling head, with reference to the machine direction, in other words with reference to the main axis or peeling axis of the peeling machine, which is defined by the axis of rotation of the peeling head. By means of this guide device, it can be guaranteed that the work piece is optimally centrally oriented in each instance with reference to the peeling head axis, in the region of the peeling head. For this purpose, it is advantageous if the guide device is centered with reference to a peeling axis of the peeling head, and it can also be advantageous if the guide device is disposed as close as possible in the vicinity of the peeling head.

The guide device can have guide rollers or corresponding slide stones that guide the work piece, whereby preferably, essentially radial guidance is performed by the guide device, while rotational forces are absorbed by the displaceable clamping device of the guide carriage, for the most part.

Another guide carriage, preferably having a clamping device that is displaceable perpendicular to the peeling axis, can be disposed on the side of the peeling head that faces away from the guide carriage. In this regard, a guide carriage on the input side and a guide carriage on the output side can be provided, so that the work piece is seized by a guide carriage at least on one side, in each instance, preferably with a displaceable clamping device, and can be displaced through the rotating peeling head as described above.

Supplementally, other guides, such as the guide device already mentioned above, which can be disposed on the input side or output side—whereby it is also easily possible to provide a guide device on both sides of the peeling head, in each instance—or a roller conveyor that has a supporting effect can be provided. Likewise, it is possible to provide additional guide carriages on the input or output side.

In this manner, it is possible to secure a work piece so as to prevent rotation, during the entire peeling process, by means of a clamping device provided on a guide carriage, in other words to counter the rotational forces applied by the peeling head.

Depending on the concrete way of conducting the method, the work piece can be clamped by the clamping devices on both sides at certain times of the peeling process, while at other times, for example directly at the beginning of the peeling process or also at its end, it is held accordingly only by a clamping device or by clamping devices that are disposed only on one side of the peeling head. In this regard, alternating clamping can also take place, so that even relatively long work pieces can be machined accordingly, in that the clamping devices engage multiple times.

If necessary, the displaceable clamping device can be fixed in place vertically relative to the guide carriage, so that it can be displaced only horizontally relative to the peeling axis. Such a configuration brings with it the significant advantage, on the one hand, that the design effort for a guide carriage is minimized, since only one-dimensional displacement of the clamping device has to be provided on the guide carriage. On the other hand, this configuration means that the displaceable clamping device can follow a curvature of the work piece only in one dimension, but in many cases this is sufficient, since the work pieces, in each instance, are frequently curved only essentially in one plane of curvature, as a result of the process. Other curvatures are frequently lower by one order of magnitude, so that in this way, material losses, since in the case of such curvatures of a higher order, too much material is removed in accordance with the known method, and accordingly, the excessive amount of material removed is significantly less.

Also, the displaceability of the clamping device provided perpendicular to the peeling axis can comprise rotatability of the clamping device, particularly perpendicular to the peeling axis.

Finally, displacement of the clamping device can take place in any possible manner, as long as the clamping device can, on the one hand, reliably absorb the rotational forces that act on it, i.e. can counter these rotational forces, and as long as it is able to guide the work piece on the curved path pre-determined by the work piece. Thus, it is possible, for example, to provide known clamping that can be additionally displaced perpendicular to the peeling axis, i.e. perpendicular to the guide path of the guide carriage, by way of a sled. This displacement can be specified by means of previously determined measurement values, for example, and applied by means of a corresponding motor system, whether this is electrical, pneumatic, or hydraulic. A displaceable clamping device that has two clamping jaws that lie opposite one another and are force-regulated, i.e. pressure-regulated, is particularly preferred. An eccentricity of the work piece resulting from the coupling then directly brings about a corresponding adaptation of the clamping jaws to this eccentricity, so that the two clamping jaws that lie opposite one another can follow such an eccentricity directly. A particularly simple embodiment follows, for example, from two communicating pneumatic or hydraulic cylinders that have the same pressure applied to them. On the other hand, it is understood that alternatively, clamping jaws addressed by way of control circuits can also be used.

As has already been explained above, it can be sufficient to configure the clamping device to be displaceable only in a plane that intersects the peeling axis, preferably in the horizontal plane. Particularly in interplay with such a configuration, but also independent of the other characteristics of the present invention, it is advantageous to provide rotational positioning of the work piece in the case of a work piece intake that guides work pieces from a bearing bed to the peeling head of the peeling machine. This makes it possible to position the work piece to be machined, particularly a round rod, for example, with regard to its rotation, in accordance with its curvature, and in this way to pre-position it in such a manner that the work piece is suitably seized by a guide carriage, a clamping device, or some other work piece intake, and transported to the peeling head. The latter can also take place in simple manner, for example, by means of axial rollers of a roller conveyor, if it is assured that the work piece does not change its rotational position in uncontrolled manner during this transport. The risk that the latter occurs can be minimized, for example, in that the work piece is rotationally positioned in such a manner that the main curvature plane of the work piece lies essentially horizontally. This position, which could be referred to colloquially as a “stable side position,” generally contains the least risk that the work piece will still change its rotational position due to gravity or in some other way.

The rotational positioning can comprise two pairs of wobble plates, for example, onto which the work piece is laid, and then the work piece can be rotated and positioned in the desired rotational position by means of rotating the wobble plates.

Depending on the concrete implementation of the present invention, the pairs of wobble plates can be vertically displaceable. In this manner, the wobble plates can, for example, raise a work piece that is lying on a bearing bed, position it rotationally in the desired manner, and then lay it back down onto the bearing bed. Alternatively or cumulatively, the work piece intake can have vertically displaceable axial rollers, or also other vertically displaceable modules of the bearing bed, by means of which a work piece can be laid down onto the wobble plates, in that these modules are displaced vertically downward. After the work piece has been rotationally positioned in suitable manner, these modules can then be raised again, so that the work piece can then be guided to the peeling head.

Particularly in order to allow rotational positioning of the work piece in operationally reliable manner, a peeling machine is proposed, cumulatively or alternatively to the other characteristics of the present invention, which is characterized by a curvature measurement device for the work piece. Such a curvature measurement device allows targeted rotational positioning of the work piece, on the one hand. On the other hand, depending on the concrete implementation of the present invention, a peeling process can also be carried out adapted to the result of the curvature measurement, without any rotational positioning having to be carried out before the beginning of the peeling process.

A curvature measurement device having a particularly simple structure can comprise at least one distance measurement device and a rotational device for rotating the work piece and/or the distance measurement device. The curvature plane is then situated at the angle position of the rod in which the smallest or greatest distance is measured, whereby this measurement takes place preferably on at least three axial position of the work piece. In this connection, it is understood that it does not play any role whether the work piece to be measured or the distance measurement device is correspondingly rotated, whereby preferably, an existing rotational positioning device can be used for rotation, so that accordingly, the distance measurement device can be configured to be fixed in place. On the one hand, multiple distance measurement devices can be provided. Likewise, on the other hand, a distance measurement device that is axially displaceable along the work piece axis can be provided.

As a solution for the above task, the invention cumulatively or alternatively proposes a peeling method, particularly for unstraightened work pieces and/or for work pieces having a diameter greater than 80 mm, in which the work piece is secured against peeling forces by means of a floating clamping device. In this connection, the floating clamping device makes it possible, as already explained in detail above, to provide rotational securing against the peeling forces, which is particularly sparing of material. Also, the floating clamping device makes it possible for a curvature of the work piece to be easily followed by the clamping device.

If a floating clamping device is provided on both sides of a peeling head, then the work piece can be clamped alternately. This particularly allows guiding the beginning and the end of a work piece through the peeling head in operationally reliable manner, by means of the floating clamping device, since even in these positions, floating clamping as described above can be implemented on at least one side. In the case of such an embodiment, input-side clamping, i.e. intake clamping, and output-side clamping, i.e. discharge clamping, is therefore present.

To the extent that intake clamping is provided, it is advantageous if the work piece is first seized by an intake clamping device and passed to the peeling head, i.e. to an intake guide that precedes the peeling head, in centered manner. In this way, the peeling process can start in operationally reliable manner, in the optimal position.

Preferably, the intake clamping device is subsequently moved away from the intake guide or from the peeling head, in order to then clamp the work piece again in accordance with its curvature. The work piece is therefore held at two positions by means of the intake guide, i.e. the peeling head, on the one hand, and by means of the intake clamping device, on the other hand. Peeling forces that are applied by means of the peeling head can be absorbed by the intake clamping device. If necessary, a discharge clamping device can clamp the work piece appropriately once the work piece has passed by the peeling head to a certain degree, so that if necessary, the intake clamping device can be opened without uncontrolled movements of the work piece coming about as a result of the peeling forces.

As has already been described above, it is correspondingly advantageous if the curvature is measured before peeling. This makes it possible to optimize adapted clamping with regard to its effort, particularly with regard to follow-up guidance as a function of the curvature. In particular, it is possible to undertake a corresponding adaptation only in one plane, preferably in a main curvature plane. If the work piece is rotationally positioned after the measurement and before peeling, then the main curvature plane can always be laid into the same geometric, i.e. spatial plane with reference to the peeling machine; in particular, the curvature plane can be laid into the horizontal direction, so that the machine effort that is required to guide the work piece through the peeling head in accordance with its curvature can be restricted to a minimum.

It is understood that the characteristics of the solutions described above and in the claims can also be combined, if applicable, in order to be able to implement the advantages in correspondingly cumulative manner.

Additional advantages, goals, and properties of the present invention will be explained using the following description of the attached drawing. The drawing shows:

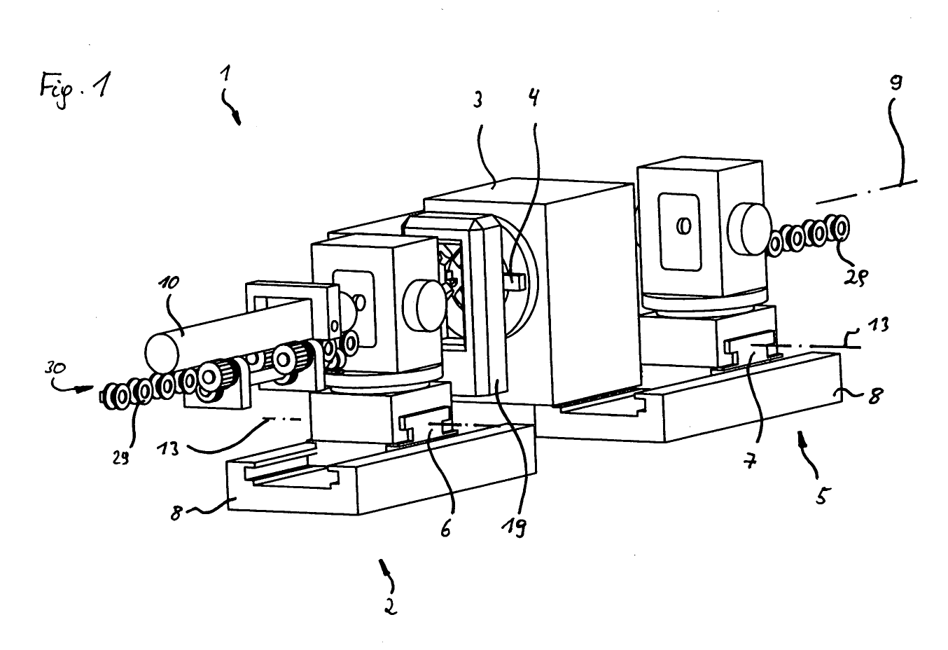

FIG. 1 a schematic overall view of a peeling machine according to the invention;

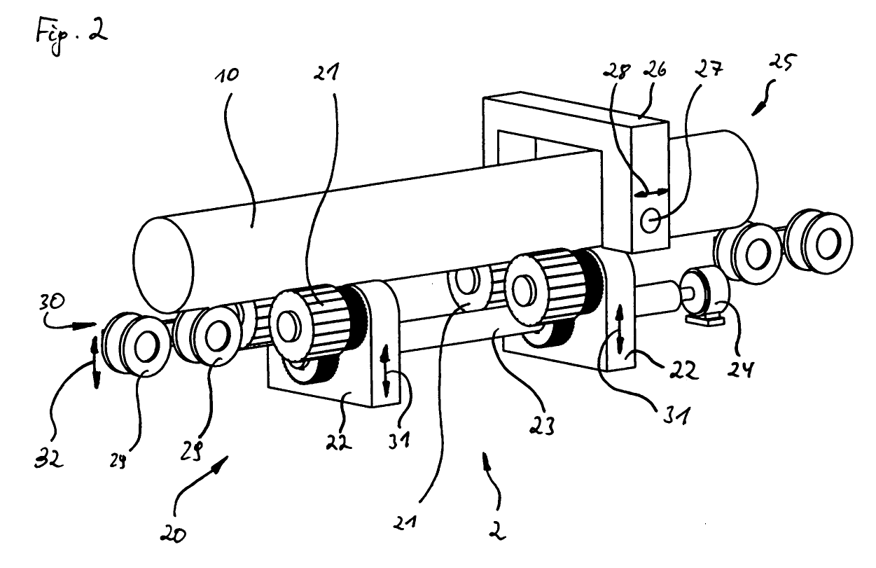

FIG. 2 a detail view of the work piece intake of the peeling machine according to FIG. 1; and

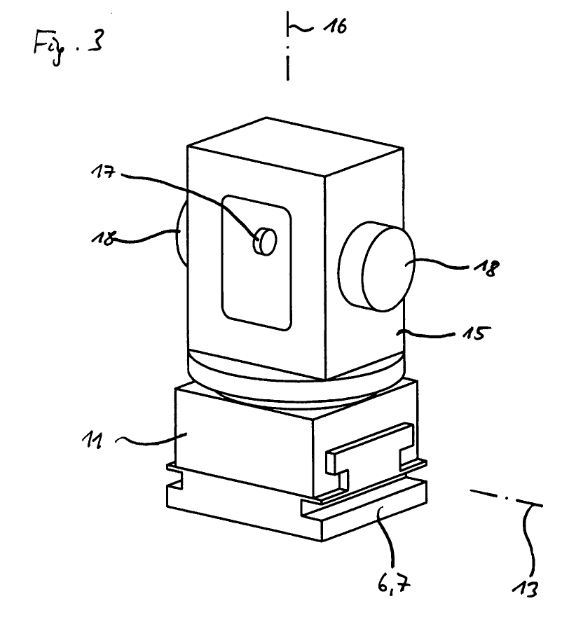

FIG. 3 a detail view of one of the two guide carriages of the peeling machine according to FIG. 1.

The peeling machine 1 shown in the drawing (FIGS. 1 to 3) comprises a work piece intake 2 that precedes a peeling unit 3 having a peeling head 4, as well as a work piece discharge 5 that follows the peeling unit 3, so that work pieces 10, such as, in particular, rods, i.e. round rods, for example, can be passed to the peeling head 4, machined by it, and then moved away again.

Both the work piece intake 2 and the work piece discharge 5 have a guide carriage 6, 7, in each instance, in this connection (intake-side guide carriage 6; discharge-side guide carriage 7), which carriages are guided in a straight line in a guide rail 8, in each instance. In this connection, the guide rails 8 are oriented essentially parallel to a peeling axis 9 that essentially represents the machine direction.

As is particularly shown in FIG. 3, the guide carriages 6, 7 carry a clamping device foot 11 that surrounds a clamping device rail 12 that is oriented in such a manner that the clamping device foot 11 can be displaced perpendicular to the peeling axis 9 (see displacement direction 13).

A clamping carrier 15 is mounted on the clamping device foot 11, on a rotary joint 14, so as to rotate about an axis of rotation 16.

In this exemplary embodiment, the clamping carrier 15 carries two clamping jaws 17 (shown as examples), which are controlled by way of hydraulic cylinders 18.

For clamping, the hydraulic cylinders 18 have a clamping pressure hydraulically applied to them, so that the clamping jaws 17 are driven into the interior of the clamping carrier 15 and clamp a work piece 10. As is directly evident, in this manner the work piece 10 can be secured to prevent rotation, particularly against peeling forces that occur by means of the peeling head 4, as a torque parallel to the peeling axis 9.

In a first implementation form of this exemplary embodiment, the rotary joint 14 and the slide connection between the clamping device foot 11 and the clamping device rail 12 are configured to be particularly low-friction, so that the clamping device foot 11 and, in particular, the clamping carrier 15 can freely follow forces that are applied by the work piece 10 in the horizontal direction, whether in the form of crosswise forces parallel to the displacement direction 13, or whether in the form of torques about the axis of rotation 16, in other words float. If a work piece 10 is therefore guided through the peeling head 4 and thus through the peeling unit 3, coaxially to the peeling axis 9, then the clamping carrier 15 moves away horizontally to the side, i.e. orients itself accordingly about the axis of rotation 16. In this way, the peeling machine 1 is able to easily follow the main curvature of a work piece, if this curvature lies essentially in the horizontal direction.

In order not to unnecessarily stress the peeling head 4 with crosswise forces, in this exemplary embodiment the peeling machine 1 also has an intake-side guide device 19 (see FIG. 1) that is disposed directly ahead of the peeling head 4, in known manner.

Depending on the concrete implementation of the present invention, a discharge-side guide device (not numbered and not shown in this exemplary embodiment) can also be provided, whereby such a discharge-side guide device is also already sufficiently known from the state of the art, with reference to a peeling head 4.

In order to be able to position the work piece 10 in the manner described as advantageous above, the peeling machine 1, and, in particular, its work piece intake 2, has a rotation positioning device 20. In this exemplary embodiment, the rotation positioning device 20 comprises wobble plates 21 (only numbered as examples), which are disposed in pairs, in each instance, on frames 22, and are driven to rotate by way of a drive shaft 23 and a drive motor 24. As is directly evident, the work piece 10 can be driven to rotate by way of the wobble plates 21, and thus can be rotationally positioned. This makes it possible to rotationally position the work piece 10 in accordance with its curvature, and, in particular, to lay the main curvature plane into the horizontal direction.

For a curvature measurement, the work piece intake 2 has a curvature measurement device 25 that has a measurement bridge 26 that can be displaced along the peeling axis 9, i.e. along an axis of the work piece 10, on which bridge two distance sensors 27 (only shown on one side) are provided. In this exemplary embodiment, the measurement bridge 26 is axially displaceable (double arrow 28) along the axis of the work piece 10, so that the distance can easily be measured at several locations, by means of the distance sensors 27. In the present exemplary embodiment, this is done in three positions (beginning of work piece, center of work piece, end of work piece), whereby it is understood that it would also be possible to measure at more positions, or also to provide multiple such measurement bridges, in order to be able to avoid axial displacement of the measurement bridge 26.

As is directly evident, it follows in this embodiment that the maximal curvature can be found where a maximal or minimal distance from the distance sensors 127 can be measured. If the drive motor 24 is then stopped at this position, the work piece 10 is directly positioned by means of the rotational positioning device 20.

In this exemplary embodiment, before rotational positioning, the work piece 10 is raised from a bearing bed 30 formed by axial rollers 29, by means of the wobble plates 21, in that the latter are vertically displaced (double arrow 31). Depending on the concrete embodiment of the present invention, the bearing bed can also have stoppers, chutes, slants, or stops, which are helpful for suitable positioning. Also, in an alternative embodiment it is possible to do without the wobble plates and to rotate the distance sensors 27 around the work piece 10, in each instance. This is particularly advantageous if rotational positioning of the work pieces 10 is not necessary, for example if the clamping carriers 15 allow an adaptation also in the vertical direction—and not only in the horizontal direction.

As is particularly shown schematically in FIG. 1, axial rollers 29 can also be provided on the discharge side, which offer corresponding support for the work piece 10.

Aside from the relatively passive configuration of the clamping device of the implementation of this exemplary embodiment, as described above, the clamping device can also be configured in active manner, particularly if the curvature measurement is made. Thus, it is possible to displace the clamping device foot 11 by means of an axial motor or some other axially effective drive, along the clamping device rail 12. Likewise, the clamping carrier 15 can be mounted on the clamping device foot 11 by way of a rotational drive. In this manner, the clamping device can actively participate in the guide work and be positioned in accordance with the curvature, in accordance with measurement values that have previously been input and other defaults, such as the peeling speed. In this way, the guide device, such as, for example, the guide device 19, can be particularly relieved of stress. Also, in an alternative implementation, it is possible to provide corresponding force sensors, so that the clamping device, although it is displaceable perpendicular to the peeling axis 9, by means of a motor, follows the defaults of the curvature essentially passively (in floating manner), in that the measurement sensor system drives the corresponding motors, for example taking crosswise forces that occur into consideration. In this connection, it is understood that combinations of the detail implementations described above are also possible. Also, it is possible to couple the two cylinders 18 in such a manner that they jointly have a pressure applied to them. If bias of the work piece 10 counter to the clamping direction of the clamping jaws 17 occurs as the result of the curvature, then the bias can resolve itself in floating manner by means of a pressure equalization in the cylinders 18, without the clamping force itself, which, in the final analysis, is predetermined by the pressure, being influenced by this, so that sufficient clamping, particularly against the peeling forces, is present at all times.

On the other hand, it is understood that in place of hydraulic cylinders, any other kind can be used in the clamping device.

In practical implementation, the work pieces 10 laid down onto a feed table can roll against a stopper or stop, as the result of a slight inclination of the feed table, and come to rest in the bearing bed 30, on the axial rollers 29 of an intake roller conveyor. Subsequently, the work piece 10 is raised by way of the wobble plates 21, along the double arrow 31, and subsequently rotated about its longitudinal axis.

In this connection, the distance measurement can take place by way of the distance sensors 27, on at least three locations of the rod, and the distance between the distance sensors 27 and the work piece 10 can be measured.

In the present exemplary embodiment, the distance sensors 27 are affixed horizontally at the level of the peeling axis 9. The curvature plane is situated in the angle position of the work piece 10 in which the smallest or greatest distance is measured. This angle position is recorded and the work piece 10 is rotated further until the curvature plane lies in the horizontal plane.

After rotational positioning of the work piece 10, the intake roller conveyor formed by the intake rollers 29 is raised to the level of the wobble plates (double arrow 32). Also, the work piece 10 is clamped by the intake-side clamping device, by means of the clamping jaws 17, before the wobble plates 21 are lowered. In this way, the angle position of the work piece 10 that was previously reached is maintained, whereby the clamping takes place in such a manner that the beginning of the work piece 10 projects about 500 mm out of the clamping carrier 15, so that it can be pushed into the intake-side guide device 19 immediately afterward. This takes place coaxially to the peeling axis.

The transport of the work piece 10 can be supported, in this connection, by means of the axial rollers 29, as well as by other rollers, not shown.

In order to push the work piece 10 in, the clamping carrier 15 guides the work piece 10 into the open intake-side guide device 19, all the way up to the peeling head 4. Then, the intake-side guide device 19 is closed, whereby guide rollers of the intake-side guide device 19, preferably supported by way of biased plate spring packets, securely clamp the work piece 10 centered on the peeling axis 9. Subsequently, the clamping jaws 17 of the intake-side guide carriage 6 are opened, and the carriage is moved back in the direction of the end of the work piece 10. The work piece is then clamped by the clamping jaws 17 of the intake-side guide carriage 6, outside of the center, in accordance with the curvature of the work piece 10. For this purpose, in the present exemplary embodiment, the clamping jaws first move to make contact with the work piece 10, without being controlled, i.e. without pressure. Afterwards, the clamping pressure is uniformly raised on both sides, and kept constant at both hydraulic cylinders 18.

Now, the intake-side guide carriage 6 pushes the work piece 10 further in the direction of the peeling head 4, and the peeling process begins.

During peeling, the middle of the process is predetermined by the intake-side guide device 10. Possible unstraight areas or curvatures of the work piece 10 that can move in the horizontal plane can be balanced out by the intake-side clamping device, in the manner already described.

As soon as the beginning of the work piece 10 leaves the peeling unit 3, the clamping jaws 17 of the discharge-side guide carriage 7, which moves synchronous to the work piece 10, clamp the work piece 10 outside of its center. Subsequently, the work piece 10 is clamped both by the clamping jaws 17 of the intake-side guide carriage 6 and by the clamping jaws 17 of the discharge-side guide carriage 7. Before the intake-side guide carriage 6 reaches the intake-side guide device 19, its clamping jaws 17 are opened, so that the work piece 10 has now been completely transferred to the discharge-side guide carriage 7.

Depending on the length of the work piece 10, a transfer between the intake-side guide carriage 6 and the discharge-side guide carriage 7 can take place multiple times.

The finished work piece 10 is then laid down on the axial rollers 29 on the discharge side.

### REFERENCE SYMBOL LIST

1 peeling machine
2 work piece intake
3 peeling unit
4 peeling head
5 work piece discharge
6 intake-side guide carriage
7 discharge-side guide carriage
8 guide rail
9 peeling axis
10 work piece
11 clamping device foot
12 clamping device rail
13 displacement direction
14 rotary joint
15 clamping carrier
16 axis of rotation
17 clamping jaw
18 hydraulic cylinder
19 intake-side guide device
20 rotational positioning device
21 wobble plate
22 frame
23 drive shaft
24 drive motor
25 curvature measurement device
26 measurement bridge
27 distance sensor
28 double arrow
29 axial roller
30 bearing bed
31 double arrow
32 double arrow

1. Peeling machine, particularly for unstraightened work pieces and/or for work pieces having a diameter greater than 80 mm, comprising a guide carriage that is axially displaceable relative to a peeling head and has a clamping device that is displaceable perpendicular to this.

2. Peeling machine according to claim 1, wherein a guide device is disposed between the guide carriage and the peeling head.

3. Peeling machine according to claim 2, wherein the guide device is centered relative to a peeling axis of the peeling head.

4. Peeling machine according to claim 1, wherein another guide carriage, preferably having another clamping device that can be displaced perpendicular to the peeling axis, is disposed on the side of the peeling head that faces away from the guide carriage.

5. Peeling machine according to claim 1, wherein the displaceable clamping device is fixed in place vertically relative to the guide carriage.

6. Peeling machine according to claim 1, wherein the displaceable clamping device can be rotated perpendicular to the peeling axis.

7. Peeling machine according to claim 1, wherein the displaceable clamping device has two clamping jaws that lie opposite one another and are force-regulated, i.e. pressure-regulated.

8. Peeling machine according to claim 1, wherein the displaceable clamping device works together with a bearing bed that comprises axial rollers.

9. Peeling machine, particularly for unstraightened work pieces and/or for work pieces having a diameter greater than 80 mm, having a peeling head and a work piece intake that guides work pieces from a bearing bed to a peeling head, wherein the work piece intake comprises a rotational positioning device for the work piece.

10. Peeling machine according to claim 9, wherein the rotational positioning device comprises at least two pairs of wobble plates.

11. Peeling machine according to claim 10, wherein the at least two pairs of wobble plates can be vertically displaced.

12. Peeling machine according to claim 9, wherein the work piece intake has vertically displaceable axial rollers.

13. Peeling machine, particularly for unstraightened work pieces and/or for work pieces having a diameter greater than 80 mm, comprising a curvature measurement device for the work piece.

14. Peeling machine according to claim 13, wherein the curvature measurement device comprises at least a distance measurement device and a rotational device for rotating the work piece and/or the distance measurement device.

15. Peeling method, particularly for unstraightened work pieces and/or for work pieces having a diameter greater than 80 mm, wherein the work piece is secured against peeling forces by means of a floating clamping device.

16. Peeling method according to claim 15, wherein a floating clamping device is provided on both sides of a peeling head, which devices alternately clamp the work piece.

17. Peeling method according to claim 15, wherein the work piece is first seized by an intake clamping device and then guided to a peeling head or to an intake guide, in centered manner.

18. Peeling method according to claim 17, wherein the intake clamping device is subsequently moved away from the peeling head, i.e. from the intake guide, and clamps the work piece in accordance with its curvature.

19. Peeling method, particularly for unstraightened work pieces and/or for work pieces having a diameter greater than 80 mm, wherein the curvature is measured before peeling.

20. Peeling method according to claim 19, wherein the work piece is rotationally positioned after measurement of the curvature and before peeling.

21. Peeling machine, particularly for unstraightened work pieces and/or for work pieces having a diameter greater than 80 mm, wherein the work piece is secured against peeling forces by means of a floating clamping device.

22. Peeling machine according to claim 21, wherein a floating clamping device is provided on both sides of a peeling head, which devices alternately clamp the work piece.

23. Peeling machine according to claim 21, wherein the work piece is first seized by an intake clamping device and then guided to a peeling head or to an intake guide, in centered manner.

24. Peeling machine according to claim 23, wherein the intake clamping device is subsequently moved away from the peeling head, i.e. from the intake guide, and clamps the work piece in accordance with its curvature.

25. Peeling machine, particularly for unstraightened work pieces and/or for work pieces having a diameter greater than 80 mm, wherein the curvature is measured before peeling.

26. Peeling machine according to claim 25, wherein the work piece is rotationally positioned after measurement of the curvature and before peeling.
